(19) United States
(12) Patent Application Publication
(10) Pub. No.: US 2025/0211826 A1
(43) Pub. Date: Jun. 26, 2025

(54) CONTENT RECOMMENDATION METHOD, STORAGE MEDIUM AND ELECTRONIC DEVICE

(71) Applicant: Beijing Youzhuju Network Technology Co., Ltd., Beijing (CN)

(72) Inventors: Xiao WANG, Beijing (CN); Qingin Tang, Beijing (CN); Xu Luo, Beijing (CN); Hongjia Wan, Beijing (CN); Wei Wang, Beijing (CN); Shangchuan Huang, Beijing (CN); Miao Luan, Beijing (CN); Yuxiao Zhou, Beijing (CN); Yanchao Dong, Beijing (CN); Ruochun Wang, Beijing (CN)

(21) Appl. No.: 18/983,097

(22) Filed: Dec. 16, 2024

(30) Foreign Application Priority Data
Dec. 26, 2023 (CN) 202311814624.2

(51) Int. Cl. H04N 21/466

(52) U.S. Cl. CPC H04N 21/4668

(57) ABSTRACT

A content recommendation method, a storage medium and an electronic device are provided. The content recommendation method includes: receiving a content request sent by a terminal device, wherein the content request carries target information for matching with recommended contents, and the target information includes attribute information of a historically delivered content and/or historical interaction information in a content material page displayed by the terminal device; obtaining a target recommended content according to the target information and a content recommendation model, wherein the target recommended content includes a target content material and analysis information for the target content material, and the content recommendation model is used for matching with recommended contents according to inputted information; and pushing the target recommended content to the terminal device such that the terminal device displays the target recommended content in the content material page.

### CROSS-REFERENCE TO RELATED APPLICATION

The present disclosure claims priority of the Chinese Patent Application No. 202311814624.2 filed on Dec. 26, 2023, the disclosure of which is incorporated herein by reference in its entirety as part of the present application.

### TECHNICAL FIELD

The present disclosure relates to a content recommendation method, storage medium and an electronic device.

### BACKGROUND

A content creation platform can provide rich content materials, to help users to stimulate creative inspiration and assist users to create contents.

### SUMMARY

This Summary section is provided to introduce concepts in a simplified form, which will be described in detail in the detailed description section later. The Summary section is not intended to identify key features or essential features of the claimed technical solution, nor is it intended to limit the scope of the claimed technical solution.

The present disclosure provides a content recommendation method, the content recommendation method including:
receiving a content request sent by a terminal device, wherein the content request carries target information for matching with recommended contents, and the target information includes attribute information of a historically delivered content and/or historical interaction information in a content material page displayed by the terminal device;
obtaining a target recommended content according to the target information and a content recommendation model, wherein the target recommended content includes a target content material and analysis information for the target content material, and the content recommendation model is used for matching with recommended contents according to inputted information; and
pushing the target recommended content to the terminal device such that the terminal device displays the target recommended content in the content material page.

The present disclosure provides a content recommendation apparatus, the content recommendation apparatus including:
a receiving module configured to receive a content request sent by a terminal device, wherein the content request carries target information for matching with recommended contents, and the target information includes attribute information of a historically delivered content and/or historical interaction information in a content material page displayed by the terminal device;
a model recommendation module configured to obtain a target recommended content according to the target information and a content recommendation model, wherein the target recommended content includes a target content material and analysis information for the target content material, and the content recommendation model is used for matching with recommended contents according to inputted information; and
a pushing module configured to push the target recommended content to the terminal device such that the terminal device displays the target recommended content in the content material page.

The present disclosure provides a non-transient computer-readable storage medium having stored thereon a computer program, wherein the computer program, when executed by a processing apparatus, implements the method of the above.

The present disclosure provides an electronic device, including:
a storage apparatus having stored thereon a computer program; and
a processing apparatus configured to execute the computer program in the storage apparatus to implement the method of the above.

### BRIEF DESCRIPTION OF DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale. In the accompanying drawings:

FIG. 1 is a flow diagram of a content recommendation method provided according to an exemplary embodiment;

FIG. 2 is a schematic diagram of a material library construction flow provided according to an exemplary embodiment;

FIG. 3 is a flow diagram of a model recommendation provided according to an exemplary embodiment;

FIG. 4 is a schematic diagram of a content recommendation apparatus provided according to an exemplary embodiment; and

FIG. 5 is a block diagram of an electronic device provided according to an exemplary embodiment.

### DETAILED DESCRIPTION

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this regard.

As used herein, the term “including” and its variants are inclusive, that is, “including but not limited to”. The term “based on” means “at least partially based on”. The term “one embodiment” means “at least one embodiment”; the term “another embodiment” means “at least one other embodiment”; and the term “some embodiments” means “at least some embodiments”. Related definitions of other terms will be given in the following description.

It is noted that the terms “first”, “second”, and the like in the present disclosure are only used for distinguishing different apparatuses, modules or units, and are not used for limiting the order or interdependence of the functions performed by these apparatuses, modules or units.

It is noted that references to “a” or “an” or “a plurality of” in the present disclosure are intended to be illustrative rather than limiting and should be understood as “one or more” by those skilled in the art, unless the context clearly indicates otherwise.

The names of messages or information exchanged between apparatuses in the embodiments of the present disclosure are for illustrative purposes only and are not intended to limit the scope of the messages or information.

It can be understood that before using the technical solutions disclosed in various embodiments of the present disclosure, users should be informed of the types, scope of use, use scenarios, etc. of personal information involved in the present disclosure in an appropriate way according to relevant laws and regulations and be authorized by the users.

For example, in response to receiving an active request from a user, prompt information is sent to the user to clearly prompt the user that an operation requested by the user to be performed will require acquisition and use of personal information of the user. Therefore, the user can independently choose whether to provide personal information to software or hardware such as an electronic device, an application program, a server or a storage medium that performs the operations of the technical solution of the present disclosure according to the prompt information.

As an optional but non-limiting implementation, in response to receiving the active request of the user, the prompt information may be sent to the user by, for example, a pop-up window, in which the prompt information can be presented in the form of text. In addition, the pop-up window can also carry a selection control for the user to choose “agree” or “disagree” to provide personal information to the electronic device.

It can be understood that the above process of notifying and acquiring user authorization is only schematic and does not limit the implementation of the present disclosure, and other ways meeting relevant laws and regulations can also be applied to the implementation of the present disclosure.

Meanwhile, it can be understood that the data referred to in this technical solution (including but not limited to the data itself, the acquisition or use of the data) should comply with the requirements of the applicable laws and regulations and related regulations.

Content materials are usually classified and displayed according to general categories, which leads to the same content materials obtained by users of the same category; and the update timeliness is low, and new inspiration cannot be effectively stimulated, thus leading to the homogenization of creative contents and inability to meet the creative needs of different users. In addition, the content materials lack guidance information and has poor usability, which makes it difficult for the users to determine whether the content materials meet their own creative needs, resulting in low content creation efficiency.

In view of this, the present disclosure provides a content recommendation method and apparatus, a readable storage medium and an electronic device to solve the above technical problems.

It should be understood that the content recommendation method of the present disclosure can be applied to a content creation platform, the content creation platform is used to provide users with content materials, stimulate users' creative inspiration and create contents, the content materials may be video materials, image-text materials and picture materials, etc., and the creative contents may include video contents, image-text contents and picture contents, etc., which are not limited by the present disclosure.

The embodiments of the present disclosure will be further explained with reference to the attached drawings.

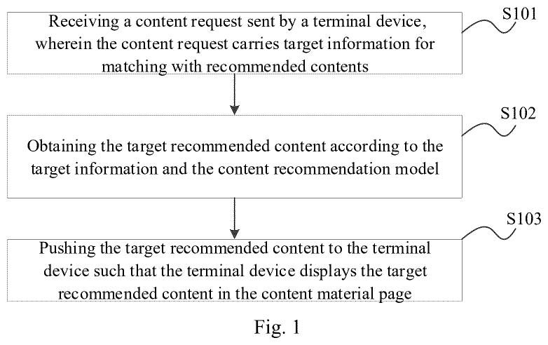

FIG. 1 is a flow diagram of a content recommendation method according to an exemplary embodiment of the present disclosure. Referring to FIG. 1, the content recommendation method includes:

S101: receiving a content request sent by a terminal device, wherein the content request carries target information for matching with recommended contents.

The target information includes attribute information of a historically delivered content and/or historical interaction information in a content material page displayed by the terminal device.

S102: obtaining the target recommended content according to the target information and the content recommendation model.

The target recommended content includes a target content material and analysis information for the target content material, and the content recommendation model is used for matching with recommended contents according to inputted information.

S103: pushing the target recommended content to the terminal device such that the terminal device displays the target recommended content in the content material page.

By using the above method, due to different historically delivered contents and historical interaction information corresponding to different users, the content materials displayed by terminal devices of different users are different, thus helping users to stimulate new inspiration, avoiding the homogenization of creative contents and meeting creative needs of different users. In addition, the content material page also displays analysis information for the content material, so that a cognitive threshold of the user can be lowered, the availability of the material can be improved, and then the efficiency of content creation can be improved.

In a possible implementation, the content recommendation method further includes: acquiring an initial content material, wherein the initial content material includes a delivered content and a multi-interest content; and analyzing the initial content material to obtain analysis information for the initial content material, and storing the initial content material and analysis information for the initial content material in the content material library, wherein the content material library is used for the content recommendation model to match with the target recommended content.

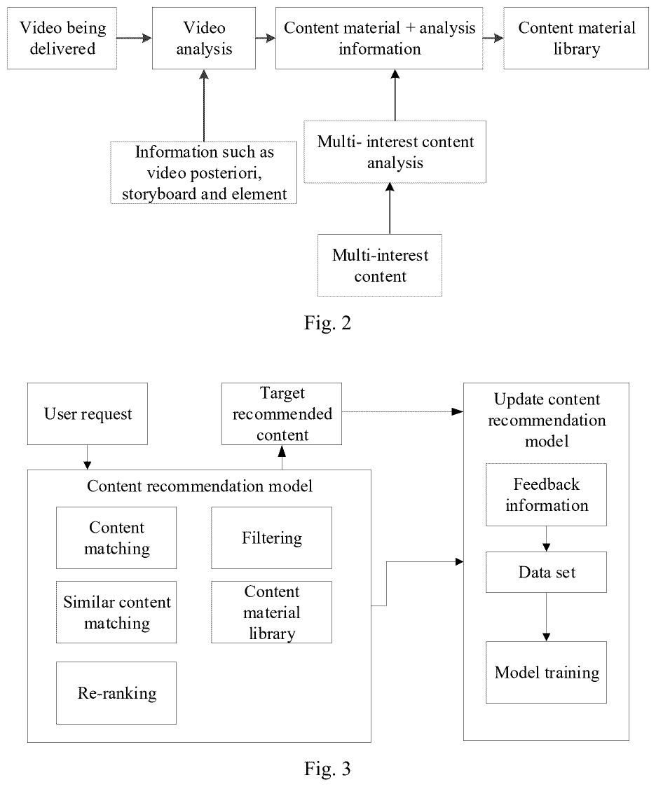

Exemplarily, referring to FIG. 2, by taking the content material as the video material as an example, the delivered content is the video content created and delivered by the user through the content creation platform, that is, a video stream being delivered. Multi-interest contents may be topics, videos, image-texts, pictures and other contents of interest obtained from different channels, for example, contents with a high browsing volume or search volume on the Internet, or contents with a high growth rate of the browsing volume or the search volume, that is, contents of interest to Internet users, which are not limited by the present disclosure. Moreover, in order to ensure the timeliness of the content material, the content material released within a preset time can also be selected, for example, the content material released within one month, which is not limited by the present disclosure.

Exemplarily, by analyzing the initial content material, such as analyzing posteriori information (which indicates a delivery data of the video content such as a click volume, a comment volume and a playback volume), storyboard information, and element information of the video content, the analysis information for the initial content material is obtained and stored together in the content material library for the content recommendation model to match with the target recommended content.

In a possible implementation, the analyzing the initial content material to obtain analysis information for the initial content material may include: analyzing the initial content material to obtain at least one selected from the group consisting of content type information, content object information, a content generation strategy, content tag information and delivery object information of the initial content material as analysis information for the initial content material.

Exemplarily, the content type information can be roughly divided into two types: a delivered content and a multi-interest content, and then subdivided into a video type, an image-text type, a picture type, etc., which is not limited by the present disclosure. The content object information refers to a subject object of the initial content material, for example, a subject object of a food video content is food. The content generation strategy may be information related to content creation, such as a content shooting technique, an editing technique, a typesetting method, etc., which is not limited by the present disclosure. The delivery object information refers to information on users to which contents are delivered, for example, delivery objects are video platform users in a region A and a region B, which is not limited by the present disclosure.

Exemplarily, the content tag information may be a feature category tag, an overall content tag, a picture tag, etc., such as a video content tag, a video plot tag, a video type tag, an image-text set format tag, a tag representing whether images and texts are spliced, an image-text content tag, a tag representing a display form of a subject in an image and text, an image-text scene tag, a picture typesetting tag, a picture scene tag, a picture entity tag, which is not limited by the present disclosure.

Accordingly, by analyzing the initial content material, the analysis information such as the content type information, the content object information, the content generation strategy, the content tag information and the delivery object information of the initial content material can be obtained, so that the subsequent content recommendation model can conveniently match with the target recommended content more accurately, and the target recommended content can be conveniently displayed in the content material page for the user to understand, lowering the cognitive threshold of the user.

It should be understood that the analysis information such as the content type information, the content object information, the content generation strategy, the content tag information and the delivery object information is usually directly carried in the attribute information of the content material, thus it can be obtained directly by analyzing the attribute information of the content material, and information not carried in the attribute information of the content material can be obtained by analyzing a content analysis model trained in advance.

In a possible implementation, the analyzing the initial content material to obtain analysis information for the initial content material may include: analyzing the initial content material through a content analysis model to obtain at least one selected from the group consisting of content structure information, a content recommendation reason and content topic information of the initial content material as analysis information for the initial content material, wherein the content analysis model is used for analyzing the inputted content material.

Exemplarily, the content analysis model can analyze the inputted content material to obtain information of the content material such as the content structure information, the content recommendation reason, the content topic information; and by taking the content material as a video content as an example, the content structure information indicates a video structure, such as a beginning, a middle and an end. The content recommendation reason can be the reason related to data delivery, such as a high click volume, or the reason related to content, such as aesthetic video images, which is not limited by the present disclosure. The content topic information is used to characterize a content topic.

The content analysis model may be a large model, a neural network model, etc. One model can be used to analyze the content structure information, the content recommendation reason, the content topic information and other information of the content material at the same time, and multiple models can be used to analyze the content structure information, the content recommendation reason, the content topic information and other information of the content material respectively. Specifically, corresponding training data can be constructed to train the content analysis model according to requirements, which is not limited by the present disclosure.

It should be understood that the above analysis information is only explained as an example, and can be specifically determined according to requirements, which is not limited by the present disclosure; for example, the category information to which the content material belongs can also be determined according to the content object information.

In a possible implementation, the obtaining the target recommended content according to the target information and the content recommendation model may include: acquiring candidate content materials matched with the target information from a content material library through the content recommendation model, and determining the target recommended content according to the candidate content materials, wherein the content material library is used for storing content materials and analysis information for the content materials.

Exemplarily, referring to FIG. 3, the candidate content materials matched with the target information can be acquired from the content material library through the content recommendation model, and then the target recommended content is determined according to the candidate content materials, so that different recommended contents can be matched according to requests of different users, thus helping users to stimulate new inspiration, avoiding the homogenization of creative contents and meeting creative needs of different users.

It should be understood that the initial content material itself contains attribute information, thus the content recommendation model can also match based on the attribute information of the initial content material; but the content material library includes the content materials and the analysis information of the content materials, and more analysis information can be obtained, thus more accurate matching can be carried out based on the content material library, which can be specifically determined according to requirements, and the present disclosure does not limit this.

In a possible implementation, the attribute information of the historically delivered content includes category information and/or delivery object information of the historically delivered content. The acquiring candidate content materials matched with the target information from a content material library through the content recommendation model may include: taking the content materials matched with the category information of the historically delivered content in the content material library as the candidate content materials through the content recommendation model; and/or, taking the content material matched with the delivery object information of the historically delivered content in the content material library as the candidate content material, through the content recommendation model.

Exemplarily, continuing referring to FIG. 3, content matching is performed through the content recommendation model, the historically delivered contents of different users are different, and the historically delivered contents can characterize delivery requirements of users; for example, if historically delivered contents of a certain user are video contents for delivering food in a region A, video materials for food in the region A can be matched, and so on, which is not limited by the present disclosure. Therefore, different recommended contents can be matched according to historically delivered contents of different users, to meet the creative needs of different users.

Further, latest historically delivered contents can be selected for matching, for example, historically delivered contents in the last 7 days and 30 days can be matched, and the historically delivered content with a highest delivery volume can also be selected for matching, which is not limited by the present disclosure.

In a possible implementation, the category information of the historically delivered content includes multi-level category information, and the taking the content materials matched with the category information of the historically delivered content in the content material library as the candidate content materials through the content recommendation model may include: acquiring first materials matched with first-level category information of the historically delivered content from the content material library through the content recommendation model; taking the first materials as the candidate content materials if a number of the first materials is greater than or equal to a first preset number; or, acquiring second materials matched with second-level category information of the historically delivered content from the content material library through the content recommendation model if the number of the first materials is less than the first preset number, and taking the second materials as the candidate content materials when a number of the second materials is greater than or equal to the first preset number, wherein a category corresponding to the first-level category information belongs to a category corresponding to the second-level category information.

It should be understood that the category information of the historically delivered content can include multi-level category information, for example, potato chips belong to a snack category, the snack category belongs to a food category, and so on, which is not limited by the present disclosure.

Exemplarily, the first preset number can be set as a minimum recommended number; if a number of the matched materials corresponding to the first-level category is less than a minimum recommended number, the matching is performed towards the upper-level category until the number of the matched materials is greater than or equal to the minimum recommended number; in this way, the number of recommended contents can be ensured and the creative inspiration of users can be effectively stimulated.

In a possible implementation, the historical interaction information includes at least one selected from the group consisting of historical material usage information, historical material browsing information and historical material collection information, and the acquiring candidate content materials matched with the target information from a content material library through the content recommendation model may include: determining historical interaction materials according to the historical interaction information; and determining content materials matched with the historical interaction materials in the content material library as the candidate content materials through the content recommendation model.

Exemplarily, the historical interaction materials, such as historical usage materials, historical browsing materials, historical collection materials, can be determined according to the historical interaction information of users on the content creation platform, which is not limited by the present disclosure, wherein the historical usage material means that the user creates contents based on this material. Further, the content material matched with the historical interaction material (for example, the content material of the same category as the historical interaction material) is recommended as a candidate content material, which is not limited by the present disclosure. Therefore, different recommended contents can be matched based on historical interaction information of different users, to meet the creative needs of different users.

In a possible implementation, the acquiring candidate content materials matched with the target information from a content material library through the content recommendation model may include: determining initial candidate content materials meeting an interaction index condition from the content material library, and determining content materials matched with the target information in the initial candidate content material as the candidate content materials, through the content recommendation model. The interaction index condition includes at least one selected from the group consisting of a historical delivery index condition, an interaction feedback index condition and a content level index condition.

Exemplarily, continuing referring to FIG. 3, the content material can be filtered. The historical delivery index may be a delivery volume of content materials, the interaction feedback index may be a click growth rate, and the content level index is used for characterizing the priority of content materials being recommended, for example, an original video has a higher level than a homogenized video and is more suitable for being recommended, and so on, which can be specifically set according to requirements, and the present disclosure does not limit this.

By setting the interaction index condition, the content materials meeting the interaction index condition can be matched, for example, content materials with a high delivery volume, content materials with a high click growth rate or content materials with a high recommendation priority can be matched, which can be set according to requirements or user requests, and the present disclosure does not limit this.

It is worth noting that the content materials meeting the interaction index condition can be filtered out first, and then category information matching, historical interaction material matching, etc. can be carried out to obtain candidate content materials, or category information matching, historical interaction material matching, etc. can be carried out first, and then candidate content materials meeting the interaction index condition can be filtered out, which can be set according to requirements, and the present disclosure does not limit this.

In addition, content materials marked by the user with dislike in the content material page can be reduced or not recommended, and the present disclosure does not limit this.

In a possible implementation, the acquiring candidate content materials matched with the target information from a content material library through the content recommendation model may include: acquiring a first content material matched with the target information and a second content material similar to the first content material from the content material library through the content recommendation model, and taking the first content material and the second content material as the candidate content materials.

Exemplarily, continuing referring to FIG. 3, similar content matching is carried out through the content recommendation model; by taking the first content material as a content material of the same category information as an example, a content material of similar category information can be matched according to the first content material, for example, if the first content material is a potato chip content material, a biscuit content material can also be matched. Or, by taking the first content material as a content material in a same delivery region as an example, for example, if the first content material is a content material delivered in a region A, and the region A is adjacent to a region B, a content material delivered in the region B can also be matched, and so on, and the present disclosure does not limit this.

In this way, similar content materials can be matched based on accurately matched content materials, so as to obtain more recommended contents and effectively stimulate the creative inspiration of users.

In a possible implementation, the obtaining the target recommended content according to the target information and the content recommendation model may include: obtaining the target recommended content according to the target information and the content recommendation model; for each of the first candidate recommended contents, determining a ranking index value of the first candidate recommended content, wherein the ranking index value is determined based on at least one selected from the group consisting of a delivery index, an aging index and a correlation index with the content request of the first candidate recommended content; and ranking the first candidate recommended content according to the ranking index value to obtain the target recommended content.

Exemplarily, with continued reference to FIG. 3, the candidate recommended contents can also be ranked to obtain the target recommended content. Weights of the delivery index, the aging index and the correlation index with the content request can be set according to requirements, and then the delivery index is multiplied by the weight of the delivery index, the aging index is multiplied by the weight of the aging index, and the correlation index is multiplied by the weight of the correlation index, and finally the three products are added to obtain a ranking index value. The present disclosure does not limit a calculation method of the ranking index value; the ranking index value can be set according to requirements, for example, the ranking index value can be determined according to the delivery index and the aging index.

The delivery index may be a delivery volume, a click volume, etc. of content materials, the aging index indicates the old and new degree of content materials, that is, the aging index of a newly released content is high; the correlation index may refer to the degree of correlation between content materials and content requests, for example, the correlation of content materials of the same category is higher than that of content materials of similar categories, and of course, ranking can be performed based on other index, which is not limited by the present disclosure.

Therefore, the candidate content materials can be ranked according to the ranking index value to obtain the target recommended content. Since the ranking index values of different users are different, even if different users are matched with the same content material, the displayed target recommended content may also be different, to meet the creative needs of different users.

In a possible implementation, the obtaining the target recommended content according to the target information and the content recommendation model may include: obtaining second candidate recommended contents according to the target information and the content recommendation model; and grouping the second candidate recommended contents according to analysis information corresponding to content materials in the second candidate recommended contents to obtain a plurality of groups of target recommended contents. The pushing the target recommended content to the terminal device such that the terminal device displays the target recommended content in the content material page may include: pushing the plurality of groups of target recommended contents to the terminal device such that the terminal device displays the plurality of groups of target recommended contents in groups in the content material page.

Exemplarily, the candidate recommended contents can be grouped according to analysis information corresponding to content materials in the candidate recommended contents to obtain a plurality of groups of target recommended contents, for example, the recommended contents of the same category can be aggregated, which is not limited by the present disclosure. Furthermore, the target recommended contents can be displayed in groups on the terminal device, for example, the target recommended contents in the same group can be aggregated into one material collection card for display, so that the user can conveniently browse the target recommended contents in the same group in a centralized way and the creative inspiration of the user can be effectively stimulated.

It is worth noting that the terminal device displays the content material and the analysis information for the content material in the content material page, which not only facilitates the user to know the type, topic, structure and other information of the content material, lowers the cognitive threshold of the user, but also can effectively stimulate the creative inspiration of the user in combination with the delivered content material and multi-interest content material in the content material.

In a possible implementation, the content recommendation method further includes: after receiving interaction feedback information for the target recommended content sent by the terminal device, updating and training the content recommendation model according to the interaction feedback information and the target recommended content to obtain a new content recommendation model.

Exemplarily, continuing referring to FIG. 3, a training data set can be constructed according to the content recommendation model and interaction feedback information for the target recommended content, and then the content recommendation model can be updated and trained to obtain a new content recommendation model. For example, the user can construct a positive sample if the user uses the recommended content materials for content creation and can construct a negative sample if the user does not use the recommended content materials for content creation, and then the content recommendation model is continuously optimized according to the positive and negative samples.

By using the above method, the creative needs of the user can be determined based on the historically delivered content and historical interaction information and other information of the users, and then the content matching and ranking are carried out based on the creative needs of the users and the content recommendation model, so as to recommend diverse content materials with high timeliness and correlation for the users. Moreover, the content analysis model can be used to analyze the content materials, thus lowering the cognitive threshold of the user.

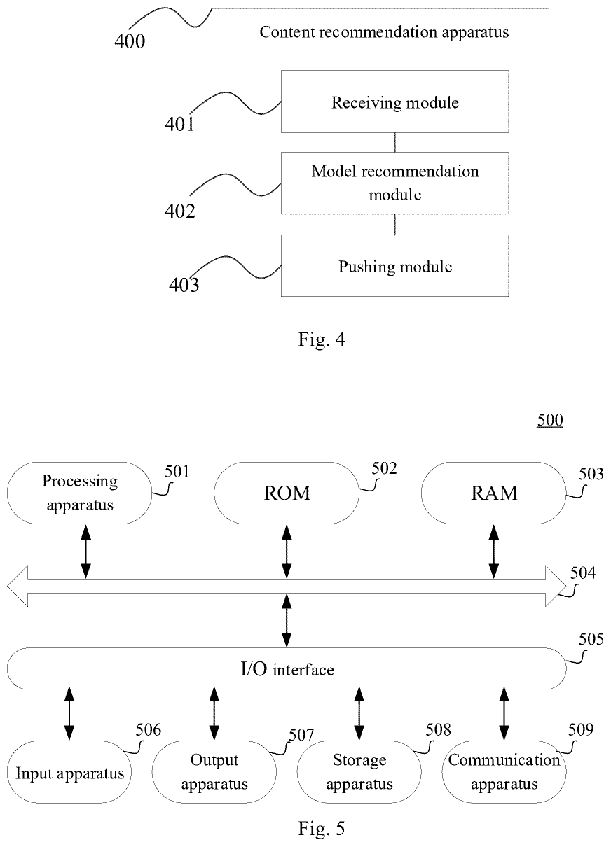

Based on the same inventive concept, the present disclosure also provides a content recommendation apparatus. Referring to FIG. 4, the content recommendation apparatus 400 includes:
a receiving module 401 configured to receive a content request sent by a terminal device, wherein the content request carries target information for matching with recommended contents, and the target information includes attribute information of a historically delivered content and/or historical interaction information in a content material page displayed by the terminal device;
a model recommendation module 402 configured to obtain a target recommended content according to the target information and a content recommendation model, wherein the target recommended content includes a target content material and analysis information for the target content material, and the content recommendation model is used for matching with recommended contents according to inputted information; and
a pushing module 403 configured to push the target recommended content to the terminal device such that the terminal device displays the target recommended content in the content material page.

By using the above apparatus, due to different historically delivered contents and historical interaction information corresponding to different users, the content materials displayed by terminal devices of different users are different, thus helping users to stimulate new inspiration, avoiding the homogenization of creative contents and meeting creative needs of different users. In addition, the content material page also displays analysis information for the content material, so that a cognitive threshold of the user can be lowered, the availability of the material can be improved, and then the efficiency of content creation can be improved.

Optionally, the model recommendation module 402 is configured to:
acquire candidate content materials matched with the target information from a content material library through the content recommendation model, and determine the target recommended content according to the candidate content materials, wherein the content material library is used for storing content materials and analysis information for the content materials.

Optionally, the attribute information of the historically delivered content includes category information and/or delivery object information of the historically delivered content;

The model recommendation module 402 includes:
a category matching module configured to take the content materials matched with the category information of the historically delivered content in the content material library as the candidate content materials through the content recommendation model; and/or,
an object matching module configured to take the content materials matched with delivery object information of the historically delivered content in the content material library as the candidate content materials through the content recommendation model.

Optionally, the category information of the historically delivered content includes multi-level category information, and the category matching module is configured to:
acquire first materials matched with first-level category information of the historically delivered content from the content material library through the content recommendation model;
take the first materials as the candidate content materials if a number of the first materials is greater than or equal to a first preset number; or,
acquire second materials matched with second-level category information of the historically delivered content from the content material library through the content recommendation model if the number of the first materials is less than the first preset number, and take the second materials as the candidate content materials when a number of the second materials is greater than or equal to the first preset number, a category corresponding to the first-level category information belonging to a category corresponding to the second-level category information.

Optionally, the historical interaction information includes at least one selected from the group consisting of historical material usage information, historical material browsing information and historical material collection information, and the model recommendation module 402 is configured to:
determine historical interaction materials according to the historical interaction information; and
determine content materials matched with the historical interaction materials in the content material library as the candidate content materials through the content recommendation model.

Optionally, the model recommendation module 402 is configured to:
determine initial candidate content materials meeting an interaction index condition from the content material library, and determine content materials matched with the target information in the initial candidate content material as the candidate content materials, through the content recommendation model, wherein the interaction index condition includes at least one selected from the group consisting of a historical delivery index condition, an interaction feedback index condition and a content level index condition.

Optionally, the model recommendation module 402 is configured to:
acquire a first content material matched with the target information and a second content material similar to the first content material from the content material library through the content recommendation model and take the first content material and the second content material as the candidate content materials.

Optionally, the model recommendation module 402 is configured to:
obtain first candidate recommended contents according to the target information and the content recommendation model;
for each of the first candidate recommended contents, determine a ranking index value of the first candidate recommended content, wherein the ranking index value is determined based on at least one selected from the group consisting of a delivery index, an aging index and a correlation index with the content request of the first candidate recommended content; and
rank the first candidate recommended content according to the ranking index value to obtain the target recommended content.

Optionally, the model recommendation module 402 is configured to:
obtain second candidate recommended contents according to the target information and the content recommendation model; and
group the second candidate recommended contents according to analysis information corresponding to content materials in the second candidate recommended contents to obtain a plurality of groups of target recommended contents; and

The pushing module 403 is configured to:
push the plurality of groups of target recommended contents to the terminal device such that the terminal device displays the plurality of groups of target recommended contents in groups in the content material page.

Optionally, the content recommendation apparatus 400 further includes:
an acquisition module configured to acquire an initial content material, wherein the initial content material includes a delivered content and a multi-interest content; and
an analysis module configured to analyze the initial content material to obtain analysis information for the initial content material and store the initial content material and analysis information for the initial content material in the content material library, wherein the content material library is used for the content recommendation model to match with the target recommended content.

Optionally, the analysis module is configured to:
analyze the initial content material to obtain at least one selected from the group consisting of content type information, content object information, a content generation strategy, content tag information and delivery object information of the initial content material as analysis information for the initial content material.

Optionally, the analysis module is configured to:
analyze the initial content material through a content analysis model to obtain at least one selected from the group consisting of content structure information, a content recommendation reason and content topic information of the initial content material as analysis information for the initial content material, wherein the content analysis model is used for analyzing the inputted content material.

Optionally, the content recommendation apparatus 400 further includes a model training module, the model training module being configured to:
after receiving interaction feedback information for the target recommended content sent by the terminal device, update and train the content recommendation model according to the interaction feedback information and the target recommended content to obtain a new content recommendation model.

With respect to the apparatus in the above-mentioned embodiment, the specific manner in which each module performs the operation has been described in detail in the embodiment related to the method, and will not be described in detail here.

Based on the same concept, an embodiment of the present disclosure also provides a non-transient computer-readable storage medium having stored thereon a computer program, wherein the computer program, when executed by a processing apparatus, implements the above-mentioned content recommendation method.

Based on the same concept, an embodiment of the present disclosure also provides an electronic device, including:
a storage apparatus having stored thereon a computer program; and
a processing apparatus configured to execute the computer program in the storage apparatus to implement the above-mentioned content recommendation method.

Reference is made to FIG. 5 below, which is a schematic diagram of a structure of an electronic device 500 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 5 is merely an example and shall not impose any limitation on the function and scope of use of the embodiments of the present disclosure.

As shown in FIG. 5, the electronic device 500 may include a processing apparatus (for example, a central processor, a graphics processor, etc.) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 1001, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touch screen, a touchpad, a keyboard, a mouse, a camera, a microphone, an accelerometer, a gyroscope, and the like; an output apparatus 507 including, for example, a liquid crystal display (LCD), a speaker, a vibrator, and the like; the storage apparatus 508 including, for example, a tape and a hard disk; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable storage medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, any currently known or future-developed network protocol such as a hypertext transfer protocol (HTTP) may be used for communication and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. The computer-readable medium also may exist independently, without being assembled into the electronic device.

The above computer-readable medium carries one or more programs that, when executed by the electronic device, cause the electronic device to: receive a content request sent by a terminal device, wherein the content request carries target information for matching with recommended contents, and the target information includes attribute information of a historically delivered content and/or historical interaction information in a content material page displayed by the terminal device; obtain a target recommended content according to the target information and a content recommendation model, wherein the target recommended content includes a target content material and analysis information for the target content material, and the content recommendation model is used for matching with recommended contents according to inputted information; and push the target recommended content to the terminal device such that the terminal device displays the target recommended content in the content material page.

Computer program code for performing operations of the present disclosure may be written in one or more programming languages or a combination thereof, where the programming languages include but are not limited to an object-oriented programming language such as Java, Smalltalk, and C++, and further include conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations or may be implemented by a combination of dedicated hardware and computer instructions.

The modules involved in the embodiments described in the present disclosure may be implemented by means of software or may be implemented by means of hardware. The name of a module does not constitute a limitation on the module in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on a chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include but is not limited to electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

The foregoing descriptions are merely preferred embodiments of the present disclosure and explanations of the applied technical principles. Persons skilled in the art should understand that the scope of disclosure involved in the present disclosure is not limited to the technical solutions formed by a specific combination of the foregoing technical features, and shall also cover other technical solutions formed by any combination of the foregoing technical features or equivalent features thereof without departing from the foregoing concept of disclosure, for example, the technical solutions formed by replacing the foregoing features with technical features with similar functions disclosed in the present disclosure (but not limited thereto).

In addition, although the various operations are depicted in a specific order, it should be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments also may be implemented in combination in a single embodiment. In contrast, various features described in a single embodiment also may be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims. With respect to the apparatus in the above embodiment, specific manners in which the modules perform operations have been described in detail in the embodiments related to the method and are not described in detail herein.

1. A content recommendation method, comprising:
receiving a content request sent by a terminal device, wherein the content request carries target information for matching with recommended contents, and the target information comprises attribute information of a historically delivered content and/or historical interaction information in a content material page displayed by the terminal device;
obtaining a target recommended content according to the target information and a content recommendation model, wherein the target recommended content comprises a target content material and analysis information for the target content material, and the content recommendation model is used for matching with recommended contents according to inputted information; and
pushing the target recommended content to the terminal device such that the terminal device displays the target recommended content in the content material page.

2. The content recommendation method according to claim 1, wherein the obtaining a target recommended content according to the target information and a content recommendation model comprises:
acquiring candidate content materials matched with the target information from a content material library through the content recommendation model, and determining the target recommended content according to the candidate content materials, wherein the content material library is used for storing content materials and analysis information for the content materials.

3. The content recommendation method according to claim 2, wherein the attribute information of the historically delivered content comprises category information and/or delivery object information of the historically delivered content;
the acquiring candidate content materials matched with the target information from a content material library through the content recommendation model comprises:
taking the content materials matched with the category information of the historically delivered content in the content material library as the candidate content materials through the content recommendation model; and/or,
taking the content materials matched with the delivery object information of the historically delivered content in the content material library as the candidate content materials through the content recommendation model.

4. The content recommendation method according to claim 3, wherein the category information of the historically delivered content comprises multi-level category information, and the taking the content materials matched with the category information of the historically delivered content in the content material library as the candidate content materials through the content recommendation model comprises:
acquiring first materials matched with first-level category information of the historically delivered content from the content material library through the content recommendation model;
taking the first materials as the candidate content materials if a number of the first materials is greater than or equal to a first preset number; or,
acquiring second materials matched with second-level category information of the historically delivered content from the content material library through the content recommendation model if the number of the first materials is less than the first preset number, and taking the second materials as the candidate content materials when a number of the second materials is greater than or equal to the first preset number, wherein a category corresponding to the first-level category information belongs to a category corresponding to the second-level category information.

5. The content recommendation method according to claim 2, wherein the historical interaction information comprises at least one selected from the group consisting of historical material usage information, historical material browsing information and historical material collection information, and the acquiring candidate content materials matched with the target information from a content material library through the content recommendation model comprises:
determining historical interaction materials according to the historical interaction information; and
determining content materials matched with the historical interaction materials in the content material library as the candidate content materials through the content recommendation model.

6. The content recommendation method according to claim 2, wherein the acquiring candidate content materials matched with the target information from a content material library through the content recommendation model comprises:
determining initial candidate content materials meeting an interaction index condition from the content material library, and determining content materials matched with the target information in the initial candidate content material as the candidate content materials, through the content recommendation model, wherein the interaction index condition comprises at least one selected from the group consisting of a historical delivery index condition, an interaction feedback index condition and a content level index condition.

7. The content recommendation method according to claim 2, wherein the acquiring candidate content materials matched with the target information from a content material library through the content recommendation model comprises:
acquiring a first content material matched with the target information and a second content material similar to the first content material from the content material library through the content recommendation model and taking the first content material and the second content material as the candidate content materials.

8. The content recommendation method according to claim 1, wherein the obtaining a target recommended content according to the target information and a content recommendation model comprises:
obtaining first candidate recommended contents according to the target information and the content recommendation model;
for each of the first candidate recommended contents, determining a ranking index value of the first candidate recommended content, wherein the ranking index value is determined based on at least one selected from the group consisting of a delivery index, an aging index and a correlation index with the content request of the first candidate recommended content; and
ranking the first candidate recommended content according to the ranking index value to obtain the target recommended content.

9. The content recommendation method according to claim 1, wherein the obtaining a target recommended content according to the target information and a content recommendation model comprises:
obtaining second candidate recommended contents according to the target information and the content recommendation model; and
grouping the second candidate recommended contents according to analysis information corresponding to content materials in the second candidate recommended contents to obtain a plurality of groups of target recommended contents; and
the pushing the target recommended content to the terminal device such that the terminal device displays the target recommended content in the content material page comprises:
pushing the plurality of groups of target recommended contents to the terminal device such that the terminal device displays the plurality of groups of target recommended contents in groups in the content material page.

10. The content recommendation method according to claim 1, wherein the content recommendation method further comprises:
acquiring an initial content material, wherein the initial content material comprises a delivered content and a multi-interest content; and
analyzing the initial content material to obtain analysis information for the initial content material and storing the initial content material and analysis information for the initial content material in a content material library, wherein the content material library is used for matching with the target recommended content by the content recommendation model.

11. The content recommendation method according to claim 10, wherein the analyzing the initial content material to obtain analysis information for the initial content material comprises:
analyzing the initial content material to obtain at least one selected from the group consisting of content type information, content object information, a content generation strategy, content tag information and delivery object information of the initial content material as analysis information for the initial content material.

12. The content recommendation method according to claim 10, wherein the analyzing the initial content material to obtain analysis information for the initial content material comprises:
analyzing the initial content material through a content analysis model to obtain at least one selected from the group consisting of content structure information, a content recommendation reason and content topic information of the initial content material as analysis information for the initial content material, wherein the content analysis model is used for analyzing the inputted content material.

13. The content recommendation method according to claim 1, wherein the content recommendation method further comprises:
after receiving interaction feedback information for the target recommended content sent by the terminal device, updating and training the content recommendation model according to the interaction feedback information and the target recommended content to obtain a new content recommendation model.

14. The content recommendation method according to claim 2, wherein the obtaining a target recommended content according to the target information and a content recommendation model comprises:
obtaining first candidate recommended contents according to the target information and the content recommendation model;
for each of the first candidate recommended contents, determining a ranking index value of the first candidate recommended content, wherein the ranking index value is determined based on at least one selected from the group consisting of a delivery index, an aging index and a correlation index with the content request of the first candidate recommended content; and
ranking the first candidate recommended content according to the ranking index value to obtain the target recommended content.

15. The content recommendation method according to claim 3, wherein the obtaining a target recommended content according to the target information and a content recommendation model comprises:
obtaining first candidate recommended contents according to the target information and the content recommendation model;
for each of the first candidate recommended contents, determining a ranking index value of the first candidate recommended content, wherein the ranking index value is determined based on at least one selected from the group consisting of a delivery index, an aging index and a correlation index with the content request of the first candidate recommended content; and
ranking the first candidate recommended content according to the ranking index value to obtain the target recommended content.

16. The content recommendation method according to claim 4, wherein the obtaining a target recommended content according to the target information and a content recommendation model comprises:
obtaining first candidate recommended contents according to the target information and the content recommendation model;
for each of the first candidate recommended contents, determining a ranking index value of the first candidate recommended content, wherein the ranking index value is determined based on at least one selected from the group consisting of a delivery index, an aging index and a correlation index with the content request of the first candidate recommended content; and
ranking the first candidate recommended content according to the ranking index value to obtain the target recommended content.

17. The content recommendation method according to claim 5, wherein the obtaining a target recommended content according to the target information and a content recommendation model comprises:
obtaining first candidate recommended contents according to the target information and the content recommendation model;
for each of the first candidate recommended contents, determining a ranking index value of the first candidate recommended content, wherein the ranking index value is determined based on at least one selected from the group consisting of a delivery index, an aging index and a correlation index with the content request of the first candidate recommended content; and
ranking the first candidate recommended content according to the ranking index value to obtain the target recommended content.

18. The content recommendation method according to claim 6, wherein the obtaining a target recommended content according to the target information and a content recommendation model comprises:
obtaining first candidate recommended contents according to the target information and the content recommendation model;
for each of the first candidate recommended contents, determining a ranking index value of the first candidate recommended content, wherein the ranking index value is determined based on at least one selected from the group consisting of a delivery index, an aging index and a correlation index with the content request of the first candidate recommended content; and
ranking the first candidate recommended content according to the ranking index value to obtain the target recommended content.

19. A non-transient computer-readable storage medium having stored thereon a computer program, wherein the computer program, when executed by a processing apparatus, implements a content recommendation method, comprising:
receiving a content request sent by a terminal device, wherein the content request carries target information for matching with recommended contents, and the target information comprises attribute information of a historically delivered content and/or historical interaction information in a content material page displayed by the terminal device;
obtaining a target recommended content according to the target information and a content recommendation model, wherein the target recommended content comprises a target content material and analysis information for the target content material, and the content recommendation model is used for matching with recommended contents according to inputted information; and
pushing the target recommended content to the terminal device such that the terminal device displays the target recommended content in the content material page.

20. An electronic device, comprising:
a storage apparatus having stored thereon a computer program; and
a processing apparatus configured to execute the computer program in the storage apparatus to implement a content recommendation method, comprising:
receiving a content request sent by a terminal device, wherein the content request carries target information for matching with recommended contents, and the target information comprises attribute information of a historically delivered content and/or historical interaction information in a content material page displayed by the terminal device;
obtaining a target recommended content according to the target information and a content recommendation model, wherein the target recommended content comprises a target content material and analysis information for the target content material, and the content recommendation model is used for matching with recommended contents according to inputted information; and
pushing the target recommended content to the terminal device such that the terminal device displays the target recommended content in the content material page.
